(19) United States
(12) Patent Application Publication
(10) Pub. No.: US 2022/0055202 A1
(43) Pub. Date: Feb. 24, 2022

(54) Striking Tool Head Mechanical Attachment System

(71) Applicant: Ciro Divittorio, Fremont, CA (US)

(72) Inventor: Ciro Divittorio, Fremont, CA (US)

(21) Appl. No.: 16/997,824

(22) Filed: Aug. 19, 2020

(51) Int. Cl. B25G 3/26

(52) U.S. Cl. CPC B25G 3/26

(57) ABSTRACT

An Apparatus defined as a bolt with large washer and lock washer and an alloy connecting bar mated together with its specifically designed wooden handle. The apparatus is mated together in the assembly process. With the striking tool head in position on the wooden handle the bolt assembly is screwed into an alloy bar which has been placed in the wooden handle. The bolt is then tightened which pulls the striking tool head into a tight wedged position.

### BRIEF SUMMARY OF INVENTION

The object of this invention is to solve the quality and reliability problems of the attachment method of striking tool heads to their handles.

Object 1

Improve over all previous attachment methods to provide a novel method to attach a tool head to the handle.

Object 2

Eliminate the traditional screw into a wedge on wooden handle which is a primary area of drying, aging and vibration. Even if the screw can be tightened over time the screw into aged wood will deteriorate causing a loose fit.

Object 3

Provide maximum life of all components in professional striking tools. Such as handles, tool heads and attachment method.

Object 4

Provide an attachment system that is compatible with the different tool head eye and handle dimension that exits in the tool manufacturing supply chain. This will allow a cost benefit vs. other methods.

### BRIEF DESCRIPTION OF THE DRAWINGS

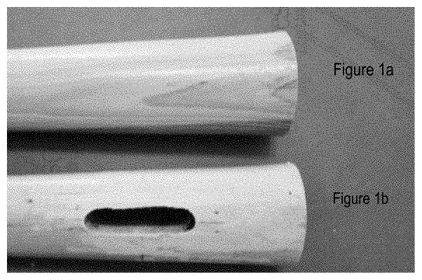

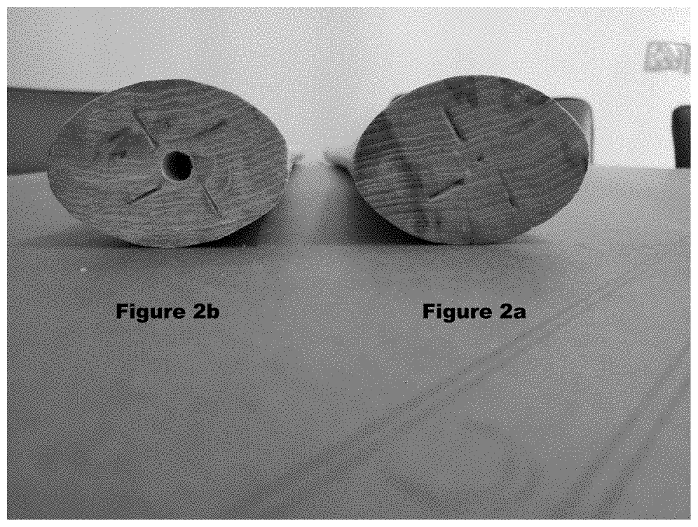

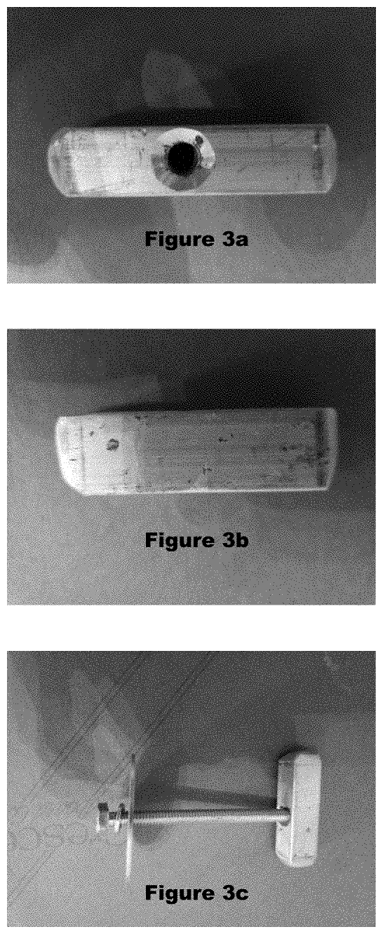

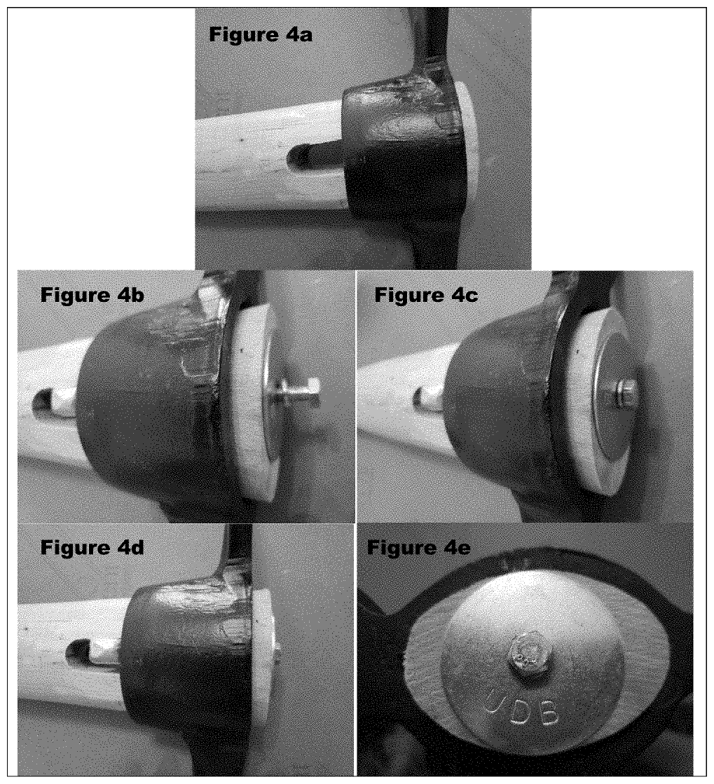

Briefly, the assembly process with reference to the drawings of the Striking Tool Head Mechanical Attachment System is as follows:
a. A slot is created in the handle to receive the alloy bar with the threaded hole. FIG. 1a shows a standard handle. FIG. 1b shows the slot created in the handle.
b. A hole is drilled in the center of the wooden handle to receive the bolt and washers. FIG. 2a shows the standard handle. FIG. 2b shows the hole that is drill into the handle.
c. FIG. 3a shows the top side view of the allow bar with the tapered area into the threads. FIG. 3b shows the side view of the allow bar. FIG. 3c shows the assembly without the tool head or handle to illustrate the assembly without the tool head or handle.
d. The wooden handle is placed in the striking tool eye. FIG. 4a
e. The alloy connecting bar is inserted into the handle slot FIGS. 4b and 4c
f. The washer assembly is placed on the bolt and the bolt is inserted in the hole. FIG. 4b and 4c

1. An attachment system which includes a modified wooden handle, a striking tool head, an alloy bar with threaded hole with a tapered entry area, long bolt with matching threads, washer and lock washer.

2. An attachment system which can be used with standard handles and tool heads from the global supply chain without need for precise milling to form a tight wedged fit.

3. An alloy bar designed with a tapered cone and threaded to receive a threaded bolt into its threads to ease assembly in the manufacturing process.
